(19) United States
(12) Patent Application Publication
(10) Pub. No.: US 2025/0230897 A1
(43) Pub. Date: Jul. 17, 2025

(54) RADIAL SPRING ROTATIONAL MOUNT

(71) Applicant: Axon Enterprise, Inc., Scottsdale, AZ (US)

(72) Inventor: Jonathan R. Hatcher, Daytona Beach, FL (US)

(21) Appl. No.: 19/019,127

(22) Filed: Jan. 13, 2025

Related U.S. Application Data
(60) Provisional application No. 63/620,670, filed on Jan. 12, 2024.

(51) Int. Cl. F16M 13/02; F16M 11/10; F16M 13/04

(52) U.S. Cl. CPC F16M 13/022; F16M 11/105; F16M 13/04

(57) ABSTRACT

A mount may comprise a mount interface, an inner portion, and an outer portion. The mount interface may releasably couple the mount to the mounting surface. The inner portion may be secured to the mount interface. The outer portion may be configured to receive the inner portion and rotate around the inner portion. The mount may comprise an accessory socket, the accessory socket comprising a socket frame and a socket arm to releasably secure an accessory. The inner portion may comprise one or more position locks and one or more contact ridges, wherein the one or more position locks switch between a locked state and an unlocked state. The outer portion may comprise one or more raised portions that releasably couple with the one or more position locks.

### FIELD OF THE INVENTION

Embodiments of the present disclosure relate to a mount.

### BRIEF DESCRIPTION OF THE DRAWINGS

The subject matter of the present disclosure is particularly pointed out and distinctly claimed in the concluding portion of the specification. A more complete understanding of the present disclosure, however, may best be obtained by referring to the detailed description and claims when considered in connection with the following illustrative figures. In the following figures, like reference numbers refer to similar elements and steps throughout the figures.

FIG. 1 is a perspective view of a mount with an attached accessory mount, in accordance with various embodiments;

FIG. 2 is a front perspective view of a mount and an accessory socket of the mount, in accordance with various embodiments;

FIG. 3 is a perspective view of a rotational mechanism of the mount, in accordance with various embodiments;

FIG. 4 is a perspective view of a plurality of mount components, in accordance with various embodiments.

Elements and steps in the figures are illustrated for simplicity and clarity and have not necessarily been rendered according to any particular sequence. For example, steps that may be performed concurrently, in different order, or omitted are illustrated in the figures to help to improve understanding of embodiments of the present disclosure.

### DETAILED DESCRIPTION

The detailed description of exemplary embodiments herein makes reference to the accompanying drawings, which show exemplary embodiments by way of illustration. While these embodiments are described in sufficient detail to enable those skilled in the art to practice the disclosures, it should be understood that other embodiments may be realized and that logical changes and adaptations in design and construction may be made in accordance with this disclosure and the teachings herein. Thus, the detailed description herein is presented for purposes of illustration only and not of limitation.

The scope of the disclosure is defined by the appended claims and their legal equivalents rather than by merely the examples described. For example, the steps recited in any of the method or process descriptions may be executed in any order and are not necessarily limited to the order presented. In some embodiments, one or more steps recited in any of the method or process descriptions may be omitted. Any reference herein to singular includes plural embodiments, and any reference to more than one component or step may include a singular embodiment or step. Reference to attached, fixed, coupled, connected, or the like may include permanent, removable, temporary, partial, full, and/or any other possible attachment option. Surface shading lines may be used throughout the figures to denote different parts but not necessarily to denote the same or different materials.

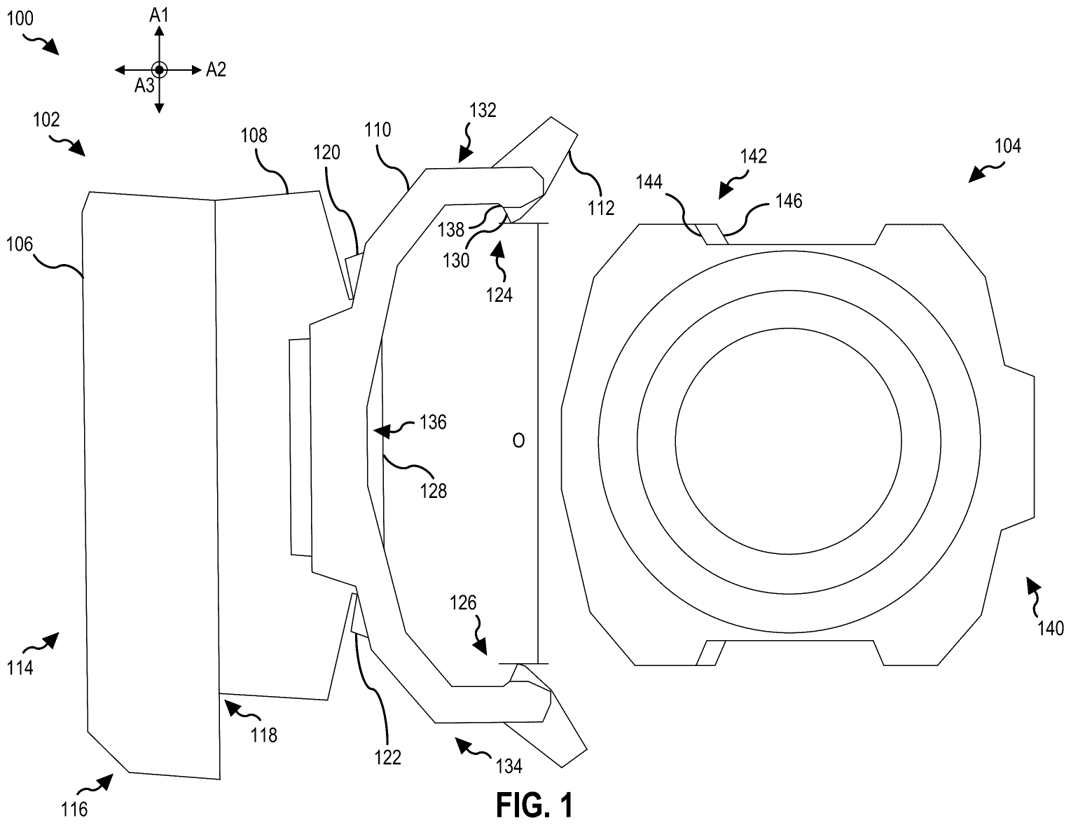

In various embodiments, and with reference to FIG. 1, a mount system 100 is disclosed. Mount system 100 may comprise a mount 102 and an accessory 104 that is secured by mount 102. Mount 102 may couple accessory 104 to an object, an article of wear, the user, and/or other mounting surface. For example, mount 102 may comprise mount interface 106, mount base 108, mount frame 110, and mount arm 112. Mount 102 may be directly or indirectly (e.g., via an intermediary, secondary mount, etc.) coupled to the mounting surface and/or accessory 104. For example, mount 102 may be coupled to an accessory mount. Alternatively, or in addition, mount 102 may be coupled to a support mount associated with the mounting surface.

Accessory 104 may comprise any suitable component desired to be mounted to a mounting surface. For example, accessory 104 may comprise a camera configured to record video and/or audio. The camera may comprise any suitable recording device, camera, microphone, or the like, such as a fixed camera, a rotating camera, a body-worn camera, a point-of-view (POV) camera, and/or the like. As a further example, accessory 104 may be configured as a projectile launcher, a designator (e.g., a laser pointer), a light source, and/or other accessory devices.

In various embodiments, mount 102 may comprise any suitable material. One or more components of mount 102 may be formed of one or more rigid, durable materials able to withstand force(s) applied to mount 102 during use. For example, one or more components of mount 102 may include one or more rigid, plastic materials, metal materials, and/or composite materials. The one or more rigid materials may include corrosion-resistant materials, UV resistant materials, and/or any other suitable material configured to at least partially withstand environmental factors. Rigid materials may include metals and metallic alloys (e.g., aluminum, steel, titanium, etc.), composites (e.g., fiberglass, carbon fiber, etc.), plastics (e.g., polycarbonate, acrylonitrile butadiene styrene, polyether ether ketone, etc.), and/or the like. The rigid materials may also be treated (e.g., heat-treated, galvanized, anodized, etc.), painted (e.g., powder-coated, e-coated, etc.), and/or coated or modified to aid in withstanding environmental factors. Additionally, one or more components of mount 102 may be formed of one or more deformable materials able to repeatedly transition between a first state (e.g., a locked state) and a second state (e.g., an unlocked state), repeatedly compress and decompress, and/or otherwise be deformed and return to an original shape of the one or more components. The one or more deformable materials may include some or all of the one or more rigid materials (e.g., plastic materials, metal materials, and/or composite materials may be configured to withstand forces applied to mount 102 and permit an amount of deformation without accumulating substantial damage to a component). Similar to the one or more rigid materials, the one or more deformable materials may include metals and metallic alloys (e.g., aluminum, steel, titanium, etc.), composites (e.g., fiberglass, carbon fiber, etc.), plastics (e.g., polycarbonate, acrylonitrile butadiene styrene, polyether ether ketone, etc.), and/or the like. Further, the deformable materials may also be treated (e.g., heat-treated, galvanized, anodized, etc.), painted (e.g., powder-coated, e-coated, etc.), and/or coated or modified to aid in withstanding environmental factors.

In various embodiments, mount 102 may comprise a mount interface 106. Mount interface 106 may comprise a first side 114, a mount opening 116, and a second side 118, the second side 118 opposite the first side 114. First side 114 may be disposed adjacent to and/or in proximity of the mounting surface. Additionally, first side 114 may at least partially couple mount 102 to the mounting surface (e.g., a portion of the mounting surface interfaces with a portion of the first side 114). Mount opening 116 may be configured to at least partially couple mount 102 to the mounting surface, optionally in combination with first side 114. For example, a portion of the mounting surface may be inserted via mount opening 116 and extend through the portion of first side 114 such that mount 102 is secured to the mounting surface. The portion of the first side 114 may be a set of ridges, rails, and/or other structures that permit the portion of the mounting surface to extend through, between, and/or behind the portion of the first side 114. Alternatively, first side 114 may comprise a coupling component configured to attach to, couple with, and/or otherwise secure first side 114 to the mounting surface.

In various embodiments, mount interface 106 may secure mount base 108 to the mounting surface via the second side 118. In particular, second side 118 may be configured to attach to, secure, and/or otherwise support mount frame 110 and mount arm 112. Second side 118 may secure at least mount frame 110 to permit rotation of mount frame 110 around an axis associated with mount frame 110.

In various embodiments, mount 102 may comprise a mount frame 110 and a mount arm 112. Mount frame 110 and mount arm 112 may define an accessory socket configured to receive and removably secure accessory 104. Mount arm 112 may be configured to permit accessory 104 to be inserted with the accessory socket and removably secure accessory 104 within the accessory socket. In particular, mount arm 112 may comprise a first arm stop 120 and a second arm stop 122. In some embodiments, first arm stop 120 and second arm stop 122 may be configured to prevent damage to first arm portion 124 and second arm portion 126. Alternatively, or in addition, first arm stop 120 and second arm stop 122 may be configured to define a first movement limit for first arm portion 124 and second arm portion 126. For example, the first movement limit may be associated with a maximum retraction of first arm portion 124 and second arm portion 126 towards mount base 108. Additionally, the first movement limit may be associated with coupling mount 102 with accessory 104.

In various embodiments, mount arm 112 may comprise a first arm portion 124 and a second arm portion 126 connected by a central arm portion 128. First arm portion 124 may extend from a first side of central arm portion 128. Second arm portion 126 may extend from a second side of central arm portion 128. The first side of central arm portion 128 may be disposed opposite of the second side of central arm portion 128 such that first arm portion 124 extends from central arm portion 128 opposite of second arm portion 126. Alternatively, or in addition, first arm portion 124 and second arm portion 126 may extend from the first side and the second side of central arm portion 128 to at least partially define the accessory socket of mount 102.

In various embodiments, mount arm 112 may comprise first arm portion 124 and second arm portion 126. First arm portion 124 and second arm portion 126 may be configured to deform such that opening O switches from a first opening state to a second opening state. The first opening state may be associated with opening O preventing accessory 104 from being inserted into and/or withdrawn from within the accessory socket. The second opening state may be associated with opening O enabling accessory 104 to be inserted into and/or withdrawn from the accessory socket. For example, the first opening state may be associated with a rest state that first arm portion 124 and second arm portion 126 return to when an opening force is removed and/or not applied. Alternatively, or in addition, the first opening state may be associated with a locked state and/or a closed state that, optionally, secures accessory 104 in association with mount 102. Further, the second opening state may be associated with an activated state that first arm portion 124 and second arm portion 126 enter under the opening force. The second opening state may be associated with first arm stop 120 and second arm stop 122 contacting mount base 108. Alternatively, or in addition, the second opening state may be associated with an unlocked state and/or an open state that, optionally, permits accessory 104 to be inserted via opening O.

In various embodiments, mount arm 112 may comprise one or more locking surfaces 130. In particular, one or more locking surfaces 130 may be associated with first arm portion 124 and second arm portion 126. For example, a locking surface 130 may be disposed on first arm portion 124 and second arm portion 126 opposite from central portion 128. Additionally, one or more locking surfaces 130 may be configured to secure accessory 104 in association with mount 102 (e.g., within the accessory socket). Further, one or more locking surface 130 may at least partially define opening O between first arm portion 124 and second arm portion 126.

In various embodiments, mount 102 may comprise a mount frame 110 configured to at least partially define the accessory socket. In particular, mount frame 110 may extend from mount base 108 to receive accessory 104 while mount arm 112 permits association of accessory 104 and mount 102. Similarly, accessory 104 may be secured in proximity to mount frame 110 by mount arm 112. For example, and while the mount arm 112 is in the first opening state, the rest state, the locked state, and/or the closed state, mount frame 110 and mount arm 112 may be aligned such that at least a portion of mount frame 110 and mount arm 112 overlap and define the accessory socket.

In various embodiments, opening O may be aligned with a first axis A1 such that opening O extends between first arm portion 124 and second arm portion 126 (e.g., between a first locking surface 130 of first arm portion 124 and a second locking surface of second arm portion 126). Additionally, a second axis A2 may extend through mount interface 106, mount base 108, mount frame 110, and/or mount arm 112. Insertion of accessory 104 into the accessory socket may provide accessory through opening O along the second axis A2. Further, a third axis A3 may extend orthogonal to the first axis A1 and the second axis A2. Mount frame 110 and mount arm 112 may overlap relative to the third axis A3. Mount frame 110 and mount arm 112 may extend along at least one of the first axis A1 and/or the second axis A2 and be aligned relative to the third axis A3.

In various embodiments, mount frame 110 may comprise a first frame arm 132 and a second frame arm 134 connected via a central frame portion 136. As noted above, first frame arm 132 may extend from central frame portion 136 at least partially aligned to first arm portion 124. Similarly, second frame arm 134 may extend from central frame portion 136 at least partially aligned to second arm portion 126. Central frame portion 136 may be at least partially aligned to central portion 128. As will be discussed below, first frame arm 132 and second frame arm 134 may be disposed proximate to and/or around first arm portion 124 and second arm portion 126 (e.g., first arm portion 124 and second arm portion 126 may be positioned between a first portion and a second portion of first frame arm 132 and second frame arm 134 along the third axis A3).

In various embodiments, first frame arm 132 and second frame arm 134 may comprise one or more raised portions 138 configured to provide support to accessory 104. In particular, one or more raised portions 138 may extend into the accessory socket from the first frame arm 132 and second frame arm 134. Extending into the accessory socket may enable one or more raised portions 138 to contact a portion of accessory 104. Contact between one or more raised portions 138 and accessory 104 may guide accessory 104 into the accessory socket, support accessory 104 within the accessory socket, and/or at least partially secure accessory 104 in association with mount 102.

In various embodiments, accessory 104 may be configured to be inserted within the accessory socket and be secured in association with mount 102. In particular, accessory 104 may be secured by mount 102 in association with a user. Additionally, accessory 104 may be secured by mount 102 such that an accessory interface 140 is accessible to the user. Further, accessory 104 may be secured by mount 102 via contact surface 142. Contact surface 142 may be comprised of one or more mount contact surfaces 144 and/or one or more frame contact surfaces 146. For example, contact surface 142 may extend from, be raised portions of, be mounted to, and/or otherwise be associated with accessory 104. One or more mount contact surfaces 144 may contact mount arm 112 and enable at least first arm portion 124 and second arm portion 126 to secure accessory 104. Alternatively, or in addition, one or more frame contract surfaces 146 may contact mount frame 110 to support accessory 104.

In various embodiments, accessory 104 may be secured by mount 102. In particular, first arm portion 124 and second arm portion 126 may transition from a rest state, a locked state, and/or other closed state to an activated, unlocked, and/or other open state to permit association of accessory 104 and mount 102. Additionally, first arm portion 124 and second arm portion 126 may transition from the activated, unlocked, and/or other open state to the rest state, locked state, and/or other closed state to secure accessory 104 in association with mount 102. Further, one or more locking surfaces 130 of first arm portion 124 and second arm portion 126 may contact at least one or more mount contact surfaces 144 to secure accessory 104. It should be noted that one or more locking surfaces 130 may be separated from one or more mount contact surfaces 144 while first arm portion 124 and second arm portion 126 are in an open state. Similarly, one or more locking surfaces 130 may be separated from one or mount contact surfaces 144 while first arm portion 124 and second arm portion 126 are in a closed state.

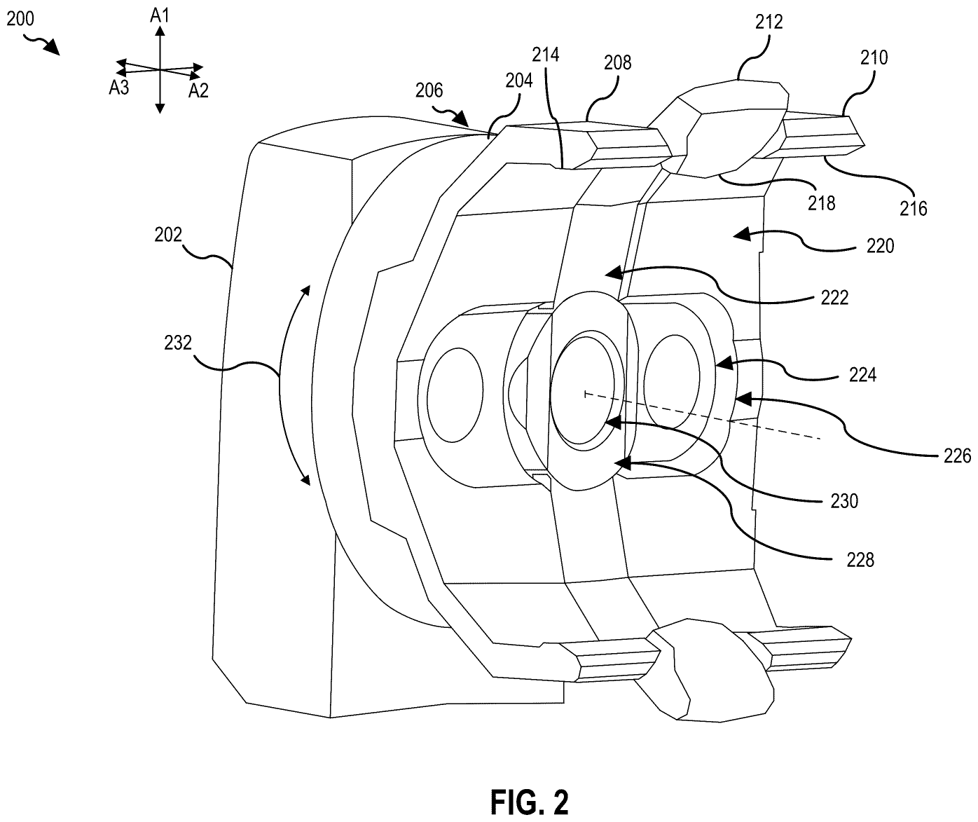

In various embodiments, and with reference to FIG. 2, a mount 200 is disclosed. Mount 200 may comprise a mount interface 202 and a mount base 204. Mount 200 may be configured to couple with and/secure an accessory to an object, an article of wear, a user, and/or other mounting surface. For example, mount 200 may comprise mount interface 202 configured to secure mount 200 to a mounting surface and mount base 204 to secure the accessory. Mount 200 may be directly or indirectly (e.g., via an intermediary, secondary mount, etc.) coupled to the mounting surface and/or accessory 104. For example, mount 200 may be coupled to an accessory mount. Alternatively, or in addition, mount 200 may be coupled to a support mount associated with the mounting surface. Mount 200 may be configured to perform one or more operations of a mount as disclosed herein. For example, mount 200 may be configured to perform one or more operations of mount 102 with brief reference to FIG. 1. One or more features of mount 102 may be further implemented as disclosed with regards to mount 200.

In various embodiments, mount interface 202 may be configured similarly to mount interface 106. In particular, mount interface 202 may be configured to interface with the mounting surface and secure mount 200 to the mounting surface. For example, the mounting surface may comprise a protrusion, a socket, a latch, and/or other surface interface configured to couple with mounting interface 202. Alternatively, or in addition, mount interface 202 may be integrated with the mounting surface such that mount 200 is attached to the mounting surface. As noted above, mounting interface 202 may comprise one or more channels, openings, protrusions, and/or other structures configured to receive, be inserted within, and/or otherwise interface with the mounting surface.

In various embodiments, mount base 204 may be coupled to mount interface 202 and secure an accessory in association with mount 200. Additionally, mount base 204 may comprise a first frame portion 208, a second frame portion 210, and a mount arm 212. Further, mount base 204 may be coupled to mount interface 202 via a rotational joint 206. Rotational joint 206 may permit rotation of mount base 204 around a central axis disposed parallel to the second axis A2. Rotation of rotational join 206 around the central axis may alter a direction that the accessory is facing, pointing, and/or otherwise aligned to along at least one of the first axis A1 or the third axis A3. Further, rotational joint 206 may be configured to lock, secure, and/or otherwise prevent adjustment of the direction that the accessory is aligned to. Alternatively, or in addition, rotational joint may be configured to unlock, release, and/or otherwise permit adjustment of the direction that the accessory is aligned to.

In various embodiments, mount base 204 may be comprised of and/or couple to one or more of first frame portion 208, second frame portion 210, and mount arm 212. In particular, first frame portion 208 and second frame portion 210 may be two portions of a mount frame (e.g., mount frame 110). Alternatively, or in addition, first frame portion 208 and second frame portion 210 may be two components that form the mount frame. Additionally, mount arm 212 may be disposed between first frame portion 208 and second frame portion 210 along the third axis A3. First frame portion 208, second frame portion 210, and mount arm 212 may be configured to define an accessory socket and receive the accessory. Further, first frame portion 208 may comprise one or more first contact surfaces 214. Similarly, second frame portion 210 may comprise one or more second contact surfaces 216. Mount arm 212 may comprise one or more securing surfaces 218.

In various embodiments, first frame portion 208 and second frame portion 210 may comprise one or more first contact surfaces 214 and one or more second contact surfaces 216. In particular, first frame portion 208 and second frame portion 210 may be formed to have a first end (e.g., a top end, the end disposed along the “up” direction of the first axis A1, etc.) and a second end (e.g., a bottom end, the end disposed along the “down” direction of the first axis A1, etc.). The one or more first contact surfaces 214 and one or more second contact surfaces 216 may be configured to contact an accessory (e.g., accessory 104) proximate to the first end and/or the second end (e.g., on a top side of the accessory and a bottom side of the accessory). Similarly, mount arm 212 may comprise one or more securing surfaces 218, the one or more securing surface 218 disposed on the first end and/or the second end of mount arm 212 (e.g., the one or more securing surfaces may be disposed on the first end and/or the second end to secure the accessory).

In various embodiments, first frame portion 208, second frame portion 210, and/or mount arm 212 may define an accessory socket. In particular, a frame surface 220 of first frame portion 208 and second frame portion 210 may at least partially define the accessory socket that receives the accessory. Similarly, arm surface 222 of mount arm 212 may at least partially define the accessory socket. A portion of frame surface 220 may receive mount arm 212 and connector cover 224 within frame socket 226. Connector cover 224 and frame socket 226 may be configured as an access plate and an access socket that enables a user to access one or more mount points that secure mount base 204 to mount interface 202. Additionally, a portion of mount arm 212 may be configured as center mount 228 that receives a rotational shaft 230.

In various embodiments, and described in greater detail below, mount base 204 may be configured to enable rotation 232 around rotational shaft 230. In particular, a first portion of mount base 204 may be configured to rotate around a second portion of mount base 204. Connector cover 224 may obscure, cover, secure, and/or otherwise provide access to one or more mount base connectors (e.g., one or more mount points that couple mount base 204 to mount interface 202) that secure the first portion of mount base 204 to mount interface 202. Additionally, rotational shaft 230 may be configured to enable rotation 232 and secure at least one of first frame portion 208, second frame portion 210, and/or mount arm 212 to the second portion of mount base 204. Accordingly, rotation 232 may cause at least first frame portion 208, second frame portion 210, and mount arm 212 to rotate around rotational shaft 230 (e.g., second axis A2). In some example embodiments, rotational shaft 230 may be configured may be configured as a bolt, screw, and/or other fastener that secures one or more components of mount 200 together.

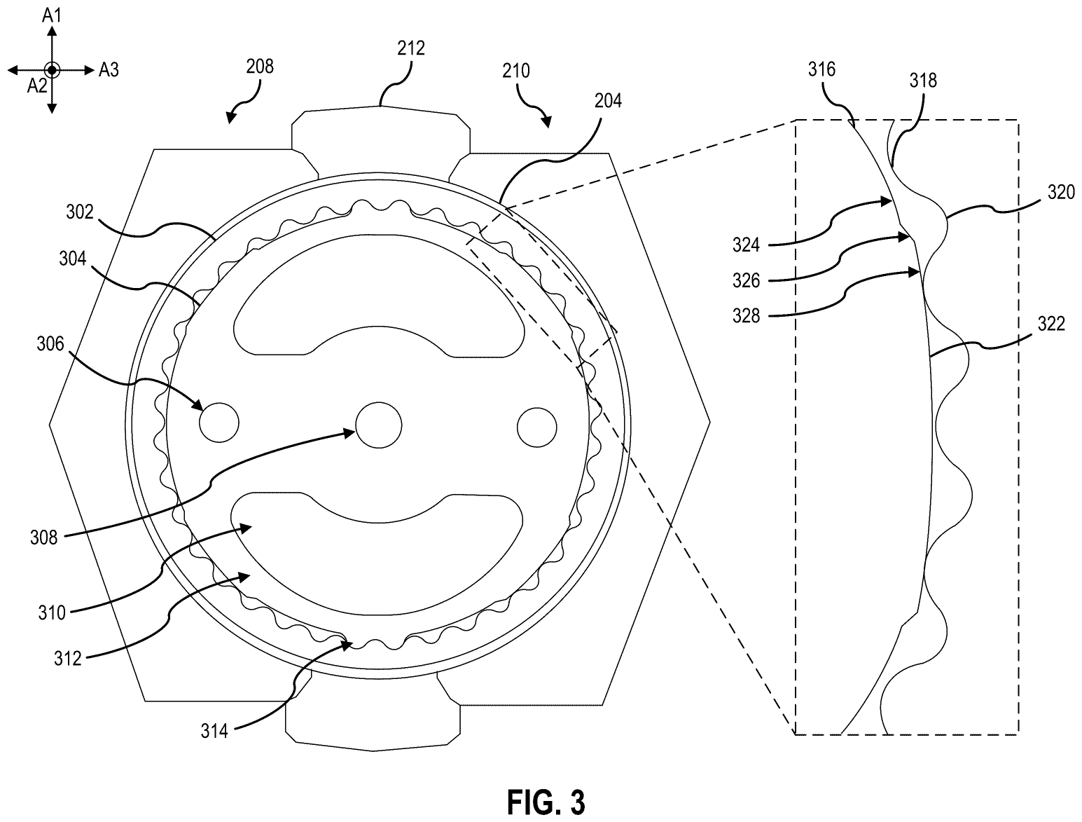

In various embodiments, and with reference to FIG. 3, a rotation mechanism for a mount (e.g., mount 200) is disclosed. The rotation mechanism may enable a mount base (e.g., mount base 204) to rotate relative to a mount interface (e.g., mount interface 202). Similarly, the rotation mechanism may enable an accessory to be secured to the mount base and rotated relative to the mount interface. Further, the mount may be configured to couple with and/secure an accessory to an object, an article of wear, a user, and/or other mounting surface. Securing the accessory to the object, the article of wear, the user, and/or mounting surface may enable rotation of the accessory relative to the mounting surface by the rotation mechanism. In some embodiments, the rotation mechanism may be designed to have a narrow depth. For example, the rotation mechanism may be minimized along axis A2. The depth of the rotation mechanism may be significantly less than a length and width of the rotation mechanism. By minimizing a depth of the rotation mechanism, an extent to which a coupled accessory extends away from the mount may also be reduced. The reduced extension of the combined mount and accessory may decrease a complexity and amount of forces necessary to secure the accessory to a mounting surface via the mount. For example, a force necessary to couple a point-of-view camera to a pair of glasses may be decreased by decreasing the depth of a mount that interconnects the camera to the pair of glasses. The decreased depth of the combined mount and camera may also decrease a likelihood that the camera may become entangled with a seat belt or other item that may pass by a user's head where the camera is mounted. Embodiments according to various aspects of the present disclosure enable a mount to have a minimized depth, which still enable an accessory coupled to the mount to be rotatably oriented.

In various embodiments, the rotation mechanism may be comprised of an outer portion 302 and an inner portion 304. Outer portion 302 may be able to rotate around inner portion 304. Alternatively, or in addition, inner portion 304 may be able to rotate within outer portion 302. While discussion below will reference outer portion 302 rotating around inner portion 304, the roles may be reversed in some additional embodiments.

In various embodiments, inner portion 304 may be secured to a mount interface via one or more attachment points 306. The one or more attachment points 306 may enable one or more fasteners to extend through inner portion 304 and couple with, attach to, and/or otherwise connect with the mount interface. Additionally, the one or more fasteners may secure inner portion 304 to the mount interface via the one or more attachment points 306. Inner portion 304 may further comprise an axis point 308 where a central fastener may secure outer portion 302 to inner portion 304. For example, inner portion 304 may be coupled to mount interface such that inner portion 304 remains associated with a user and/or a mounting surface. Inner portion 304 may be secured such that inner portion 304 remains stationary relative to the user and/or the mounting surface. Alternatively, or in addition, inner portion 304 may be secured such that outer portion 302 rotates relative to the user and/or the mounting surface. As noted above, inner portion 304 may be secured by one or more attachment points 306.

In various embodiments, inner portion 304 may be configured to secure outer portion 302 and enable rotation of outer portion 302. In particular, outer portion 302 may be secured to inner portion 304 such that outer portion 302 rotates around axis point 308. Axis point 308 may comprise a channel that extends from outer portion 302 to inner portion 304, wherein the channel may extend through at least one of outer portion 302 and/or inner portion 304. Axis point 308 may comprise a fastener that secures outer portion 302 to at least inner portion 304 and permits outer portion 302 to rotate around axis point 308. The fastener may be configured as a screw, bolt, rivet, and/or other fastener that causes outer portion 302 to interface with inner portion 304. Accordingly, outer portion may be secured to the user and/or the mounting surface via the axis point 308 and inner portion 304. Similarly, outer portion 302 may rotate relative to the user and/or the mounting surface around axis point 308.

In various embodiments, inner portion 304 may comprise at least one deformation volume 310, perimeter portion 312, and position lock 314. In particular, inner portion 304 may comprise one or more deformation volumes 310 that permit one or more perimeter portions 312 to deform and enable rotation of outer portion 302. Additionally, deformation of the one or more perimeter portions 312 may disengage one or more position locks 314 from outer portion 302 and enable rotation of outer portion 302. For example, perimeter portion 312 may be associated with a force threshold that, when satisfied by an applied force, results in perimeter portion 312 deformed to disengage position lock 314. Disengaging position lock 314 may permit outer portion 302 to rotate around inner portion 304. Disengaging position lock 314 may comprise the applied force causing the perimeter portion 312 to traverse radially inward from the outer portion 302. Further, deformation volume 310 may receive perimeter portion 312 when the applied force satisfies the force threshold. Alternatively, or in addition, deformation volume 310 may be reduced in size when the applied force deforms perimeter portion 312 to disengage position lock 314 from outer portion 302.

In various embodiments, deformation volume 310 may be configured as a volume, a space, a void, and/or other opening within the structure of inner portion 304. Deformation volume 310 may be defined, enclosed, and/or otherwise formed by at least one of the structures of inner portion 304 and/or perimeter portion 312. Generally, a deformation volume may be configured as a volume within a structure that enables the structure to deform, change shape, and/or otherwise switch between two or more states in response to a stimulus (e.g., an applied force). For example, an applied force applied to inner portion 304 (e.g., perimeter portion 312, position lock 314, etc.) may cause perimeter portion 312 to compress deformation volume 310 as the structure of perimeter portion 312 moves towards axis point 308. Additionally, removal of the applied force from inner portion 304 may result in deformation volume 310 expanding as perimeter portion 312 returns to a rest state. Inner portion 304 may be configured to comprise one or more deformation volumes 310 to enable deformation of inner portion 304 to disengage position lock 314 from outer portion 302.

In various embodiments, perimeter portion 312 may be a portion of inner portion 304 that defines an outer edge of inner portion 304 proximate to outer portion 302. Perimeter portion 312 may define one or more deformation volumes 310, comprise one or more position locks 314, and/or comprise one or more contact ridges 322. In particular, perimeter portion 312 may be a segment of inner portion 304 that extends radially outward of deformation volume 310 around a circumference of inner portion 304. Perimeter portion 312 may comprise one or more position locks 314. Perimeter portion 312 may be configured to deform, switch from a first state (e.g., a locked state) to a second state (e.g., an unlocked state), and/or otherwise be translated towards axis point 308 by an applied force. The applied force may be received by the perimeter portion 312 in response to a rotational force being applied to outer portion 302 and/or inner portion 304. Application of the rotational force may induce position lock 314 and one or more raised portions 318 to contact and convert the rotational force into the applied force (e.g., a rotational force applied to a sloped contact point may cause the two sloped surfaces to move perpendicular to the rotational force). Conversion of the rotational force into the applied force may cause perimeter portion 312 to translate towards axis point 308 and enable position lock 314 to rotate past one or more raised portions 318 and/or one or more raised portions 318 to rotate past position lock 314.

In various embodiments, perimeter portion 312 may comprise one or more position locks 314 and one or more contact ridges 322. One or more position locks 314 may be disposed proximate to one or more deformation volumes 310 such that at least a segment of perimeter portion 312 may translate into one or more deformation volumes 310. Additionally, one or more position locks 314 may be separated from one or more contact ridges by one or more additional segments of perimeter portion 312, wherein the one or more additional segments are associated with first level 324. It should be noted that the one or more additional segments may lack raised portion(s), teeth, and/or other structures. In some embodiments, inner portion 304 may comprise one, two, three, five, or more position locks 314. In some additional embodiments, outer portion 302 may comprise two, five, ten, thirty, or more raised portions 318 associated with a plurality of rotational positions. Generally, a number of raised portions 318 may exceed a number of position locks.

In various embodiments, position lock 314 may be configured as one or more structures disposed on a radially outer surface 316 of perimeter portion 312 and/or inner portion 304. In particular, position lock 314 may be configured to receive one or more raised portions 318 of outer portion 302 to secure outer portion 302 and/or inner portion 304 in one or more rotational positions. Position lock 314 may be configured such that perimeter portion 312 is capable of translating a distance towards axis point 308 greater than a position lock height. Translating perimeter portion 312 the distance towards axis point 308 enables position lock 314 to translate past one or more raised portions 318 of outer portion 302. Generally, a position lock may be configured as a structure on a first portion of a device that engages and disengages with a matching structure on a second portion of the device. The position lock may be configured to transition between a first state that prevents modification of a position of the device and a second state that enables modification of the position of the device. For example, position lock 314 may be configured to have a rest state that prevents rotation of outer portion 302 around inner portion 304. An activated state of position lock 314 may enable rotation of outer portion 302 around inner portion 304.

In various embodiments, inner portion 304 may comprise deformation volume 310 that enables position lock 314 to disengage from outer portion 302. In particular, one or more position locks 314 may extend radially outward from an outer surface 316 of inner portion 304. Additionally, one or more position locks 314 may be configured to interface with one or more raised portions of outer portion 302 and/or be received by one or more recessed portions 320 of outer portion 302. For example, the force threshold may be associated with the applied force that causes one or more position locks 314 to disengage from at least one of raised portion 318 and/or recessed portion 320. Further, the force threshold may be associated with the applied force that causes outer portion 304 to rotate such that position lock 314 transfers from a first raised portion 318 and/or first recessed portion 320 to a second raised portion 318 and/or a second recessed portion 320. Transferring position lock 314 from the first raised portion 318 and/or first recessed portion 320 to the second raised portion 318 and/or a second recessed portion 320 may comprise perimeter portion 312 compressing deformation volume 310 to permit transfer of position lock 314.

In various embodiments, outer portion 302 may be secured in any one of a plurality of rotational positions by position lock 314. In particular, position lock 314 may interface with a set of the one or more raised portions 318 and/or the one or more recessed portions 320 of outer portion 302 to secure outer portion 302 in a rotational position. Additionally, position lock 314 may be disengaged from outer portion 302 to permit rotation of outer portion 302 between individual rotational positions of the plurality of rotational positions.

In various embodiments, outer portion 302 may comprise one or more raised portions 318 and/or one or more recessed portions 320 disposed on a radially inward surface of outer portion 302. Additionally, one or more raised portions 318 and/or one or more recessed portions 320 may be disposed proximate to and radially outward from outer surface 316 of inner portion 302. Outer surface 316 may further comprise a contact ridge 322. In particular, one or more raised portions 318 may be spaced from outer surface 316 of inner portion 302. Contact ridge 322 may extend radially outward from outer surface 316 and contact one or more raised portions 318. Further, contact between contact ridge 322 and one or more raised portions 318 may at least partially align outer portion 302 and inner portion 304.

In various embodiments, one or more raised portions 318 and contact ridge 322 may align outer portion 302 with inner portion 304 such that outer portion 302 may rotate radially outside of inner portion 304. In particular, one or more raised portions 318 may be configured such that one or more raised portions 318 contact and, during rotation of outer portion 302, translate along contact ridge 322 to modify a rotational position of outer portion 302. It should be noted that, at least partially in response to the applied force, a number of raised portions 318 may change in response to the applied force disengaging position lock 314 from one or more raised portions 318. For example, disengaging position lock 314 from one or more raised portions 318 may cause perimeter portion 312 to transition from a first state to a second state. The first state may be associated with a rest state of perimeter portion 312 and the second state may be associated with a modified state of perimeter portion 312 where the applied force causes perimeter portion to translate towards at least one of attachment point 306 and/or axis point 308. Transitioning from the first state to the second state may alter the number of raised portions 318 in contact with contact ridge 322 by causing a portion of contact ridge 322 to be retracted from one or more raised portions 318. Alternatively, transitioning from the first state to the second state may cause a portion of perimeter portion 312 to approach one or more raised portions 318 such that the portion of perimeter portion 312 is in contact with and/or proximate to one or more raised portions 318.

In various embodiments, outer portion 302 may comprise one or more raised portions 318 associated with a plurality of rotational positions. One or more position locks 314 of inner portion 304 may be configured to couple with a set of the one or more raised portions to secure outer portion in a rotational position of the plurality of rotational positions. In particular, outer portion 302 may comprise a number of raised portions 318, the number of raised portions 318 greater than a number of position locks 314, that may translate along one or more contact ridges 322 between the plurality of rotational positions. A position lock 314 may comprise one or more lock extensions that extend from perimeter portion 312 and, optionally, interface with the one or more raised portions 318. For example, a position lock 314 may comprise a first lock extension and a second lock extension. When inner portion 304 is in a locked state, the position lock 314 may interface with a first raised portion, a second raised portion, and a third raised portion. When inner portion 304 is in an unlocked state, the position lock may disengage from the one or more raised portions 318 of outer portion 302. Further, and after outer portion 302 has been rotated around inner portion 304, the position lock 314 may return to the locked state and interface with a fourth raised portion, a fifth raised portion, and a sixth raised portion. Alternatively, or in addition, a second position lock 314 may interface with the first raised portion, the second raised portion, and the third raised portion.

In various embodiments, perimeter portion 312 may comprise a first level 324 associated with a first outer radius of perimeter portion 312. Perimeter portion 312 may comprise a second level 328 associated with a second outer radius of perimeter portion and contact ridge 322. Perimeter portion 312 may transition from first level 324 to second level 328 via a slope 326. For example, inner portion 304 may be configured as a circular structure associated with a first outer radius defined by first level 324 and a second outer radius defined by second level 328. Slope 326 may be configured as the transition from the first level 324 to the second level 328. Slope 326 may be configured to enable one or more raised portions 318 to translate from first level 324 to second level 328. For example, decoupling position lock 314 from a raised portion 318 may cause perimeter portion 312 to flex such that a portion of perimeter portion 312 contacts one or more raised portions 318 in addition to contact ridge 322. As outer portion 302 rotates from a first rotational position to a second rotational position, one or more raised portions 318 may move along first level 324, onto slope 326, and/or onto second level 328. Alternatively, or in addition, one or more raised portions 318 may move along second level 328, onto slope 326, and/or onto first level 324.

In various embodiments, outer portion 302 may be configured to translate around inner portion 304 between one or more rotational positions. In particular, position lock 314 may be configured such that, absent an applied force that satisfies a force threshold for disengaging position lock 314 from outer portion 302, position lock 314 returns to a locked state, a rest state, and/or other default state that secures outer portion 302. Disengaging position lock 314 from outer portion 302 may cause perimeter portion 312 to transition from a rest state to a compressed state. Perimeter portion 312 may be configured such that the applied force causes first level 324 to translate towards axis point 308 and contact ridge 322 remains in contact with outer portion 302. Additionally, translation of first level 324 towards axis point 308 may cause a first portion of perimeter portion 312 associated with first level 324 to flex, bend, translate, deform, and/or otherwise move and a second portion of perimeter portion 312 associated with second level 328 to remain in contact with outer portion 302. For example, the first portion of perimeter portion 312 that is associated with first level 324 may comprise a first structure thickness that permits the first portion of perimeter portion 312 to flex, bend, translate, deform, and/or otherwise move towards axis point 308. Additionally, the second portion of perimeter portion 312 associated with second level 328 may comprise a second structure thickness that restricts flexing, bending, deformation, translation, and/or other movement of the second portion. Further, the first portion associated with first level 324 may be separated from the second portion associated with second level 328 by slope 326.

In various embodiments, the second portion of perimeter portion 312 associated with second level 328 may be configured to cause perimeter portion 312 to return to the rest state when the applied force is removed. In particular, outer portion 302 may be utilized to provide the applied force to rotate between a first rotational position and a second rotational position. Upon reaching the second rotational position, the applied force may be removed from perimeter portion 312 and permit position lock 314 to reengage with outer portion 302 to secure outer portion in the second rotational position. As noted above, the applied force causes perimeter portion 312 to translate towards axis point 308 and to switch from a rest state to a modified state (e.g., a compressed state, a deformed state, a decoupled state, etc.). It should be noted that, in the modified state, the first portion of perimeter portion 312 associated with first level 324 may transfer the applied force to the second portion of perimeter portion 312 associated with second level 328. Additionally, the modified state may be associated with a force equilibrium where the applied force permitting rotation of outer portion 302 is balanced by an opposing force applied by outer portion 302 to at least one of contact ridge 322 and/or the second portion associated second level 328. In response to the applied force being removed, the opposing force may cause the first portion associated with first level 324 to return to the rest state from the modified state.

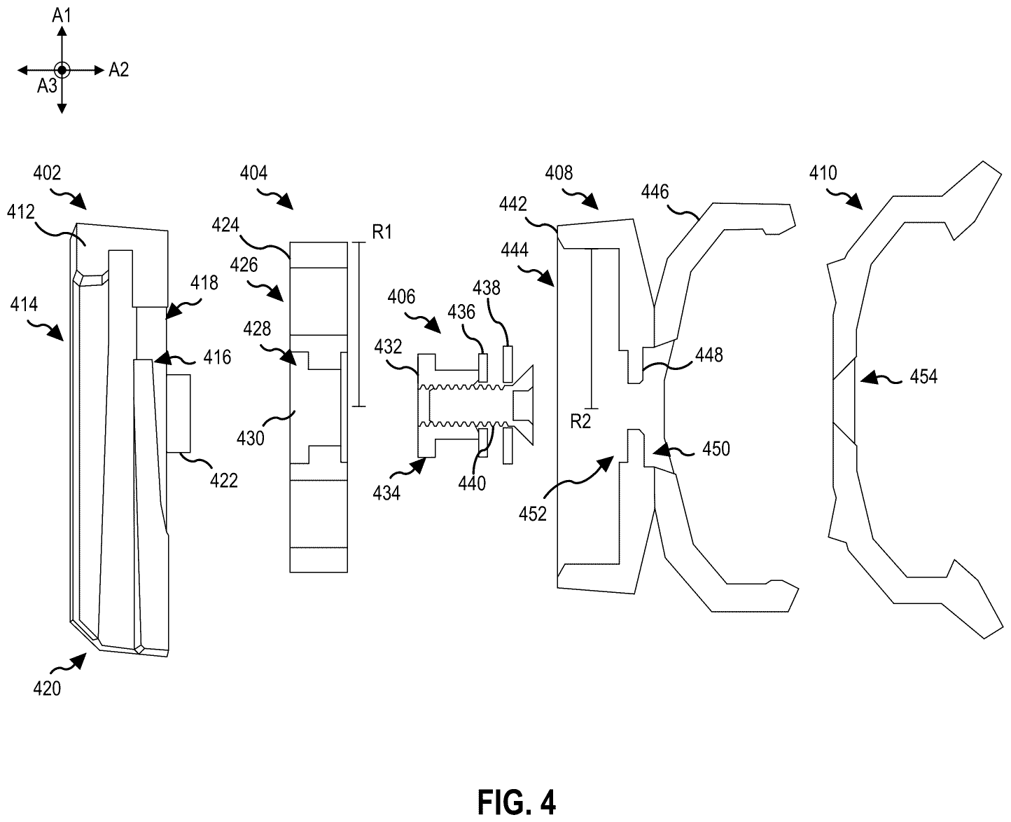

In various embodiments, and with reference to FIG. 4, a mount (e.g., mount 200) is disclosed. The mount may be assembled from a mount interface 402, an inner mount portion 404, a connector 406, an outer mount portion 408, and a mount arm 4. The mount may enable an accessory to be secured to the mount base and rotated relative to the mount interface. Further, the mount may be configured to couple with and/secure an accessory to an object, an article of wear, a user, and/or other mounting surface. Securing the accessory to the object, the article of wear, the user, and/or mounting surface may enable rotation of the accessory relative to the mounting surface by a user of the mount.

In various embodiments, mount interface 402 may be configured to attach the mount to a mounting surface (e.g., an object, an article of wear, a user, etc.). The mount interface 402 may comprise a mount interface hull 412, a mount interface opening 414, a mount interface catch 416, a mount interface rear opening 418, an internal volume 420, and one or more base mounting points 422. Mount interface hull 412 may be formed to provide support for the mount and stabilizing the accessory relative to the mounting surface. Mount interface hull 412 may be configured as a cuboid structure, a semi-spherical structure, and/or other structure that may receive a portion of the mounting surface, receive a portion of a mounting surface interface, and/or be coupled to the mounting surface. For example, mount interface hull 412 may be at least partially hollow, the internal volume 420 open to receive a portion of the mounting surface and/or receive a portion of a mounting surface interface. The portion of the mounting surface and/or the mounting surface interface can be received via mount interface opening 414. Further, the portion of the mounting surface and/or the mounting surface interface may couple with mount interface catch 416 and extend through mount interface rear opening 418.

In various embodiments, mount interface 402 may be configured to support one or more other components of the mount. In particular, mount interface 402 may comprise one or more base mounting points 422 that may receive and secure at least the inner mount portion 404. For example, one or more fasteners may extend from inner mount portion 404 to one or more base mounting points 422. It should be noted that a plurality of fasteners may be utilized to secure inner mount portion 404 to mount interface 402 and prevent inner mount portion 404 from shifting, dislodging, and/or otherwise disassociating from mount interface 402.

In various embodiments, inner mount portion 404 may comprise perimeter structure 424, one or more deformation volumes 426, a central seat 428, and a central channel 430. In particular, inner mount portion 404 may be configured to enable rotation of outer mount portion 408 around inner mount portion 404 via connector 406. As discussed above, one or more portions of perimeter structure 424 may be configured to transition between a locked state and an unlocked state. The locked state may be associated with the perimeter structure 424 being in a base state, a rest state, a default state, and/or other baseline configuration of the perimeter structure 424. When the mount is assembled and in the locked state, perimeter structure 424 may couple with outer mount portion 408 and secure outer mount portion 408 in a rotational position. Additionally, perimeter structure 424 may be configured as a disk and/or other three-dimensional shape having at least an external radius R1. It should be noted that external radius R1 may be associated with the locked state of perimeter structure 424 and that the unlocked state of perimeter structure 424 may be associated with a variable external radius based at least on deformation of perimeter structure 424 that disengages one or more position locks from outer mount portion 408.

In various embodiments, inner mount portion 404 may comprise one or more deformation volumes 426. In particular, one or more deformation volumes may be at least partially defined by perimeter structure 424 and a wall of central channel 430, and/or other structures associated with inner mount portion 404. Additionally, one or more deformation volumes 426 may be configured to change shape based at least on inner mount portion 404 transitioning between the locked state and the unlocked state.

In various embodiments, inner mount portion 404 may comprise a central seat 428 and a central channel 430. Central seat 428 may be configured to receive a first ridge 434 of connector 406. Similarly, central channel 430 may be configured to receive connector hull 432. In particular, central seat 428 may be configured to prevent translation of connector 406, outer mount portion 408, and/or mount arm 410 along a second axis A2. Central seat 428 may be associated with a wider portion of central channel 430 that provides an opening for installation of connector hull 432 within central channel 430. Additionally, central seat 428 may be configured to receive first ridge 434 and prevent translation of first ridge 434 past central seat 428 and into central channel 430. Central channel 430 may be configured to receive connector hull 432 and, when connector 406 is fully assembled, permits connector hull 432 to rotate around the second axis A2.

In various embodiments, connector 406 may be configured to couple outer mount portion 408 to inner mount portion 404 and enable rotation of outer mount portion 408 around inner mount portion 404. In particular, connector 406 may comprise connector hull 432, first ridge 434, second ridge 436, access plate 438, and fastener 440. As noted above, connector hull 432 may be configured to be inserted within central channel 430 to secure outer mount portion 408 to inner mount portion 404. Additionally, first ridge 434 may secure connector hull 432 via central seat 428 and prevent translation of connector hull 432 in at least a first direction along second axis A2 (e.g., preventing translation of connector hull 432 towards outer mount portion 408 past central seat 428). Similar to first ridge 434, second ridge 436 may be configured to contact inner mount portion 404 and secure connector 406 in association with central channel 430. Further, second ridge 436 may be configured to prevent translation of connector hull 432 in a second direction along the second axis A2, the second direction opposite the first direction (e.g., preventing translation of connector hull 432 towards inner mount portion 404).

In various embodiments, connector 406 may be secured within central channel 430. For example, fastener 440 may secure connector 406 and connector hull 432 within central channel 430. In particular, installation of fastener 440 may comprise mating threads and/or other structures of fastener 440 with additional threads and/or other additional structures internal to connector hull 432. Installing fastener 440 within connector hull 432 may apply a force that secures connector 406 via first ridge 434 contacting central seat 428 and second ridge 436 contacting an additional seat of central channel 430 and/or inner mount portion 404. Additionally, installing fastener 440 within connector hull 432 may apply a compressive force that secures connector 406 along the second axis A2.

In various embodiments, connector 406 may comprise an access plate 438 that may protect one or more mounting points 422. In particular, one or more mounting points 422 can be distributed along the third axis A3. For example, connector hull 432 may be disposed along a central axis of the mount and one or more mounting points 422 can be disposed radially outward from connector hull 432 along the first axis A1 and/or the third axis A3. Additionally, access plate 438 may be secured by fastener 440 to cover, protect, obstruct, and/or otherwise obscure one or more mounting points 422.

In various embodiments, outer mount portion 408 may comprise a frame base 442, an internal socket 444, a socket frame 446, and a connector interface 448. In particular, outer mount portion 408 may be secured to inner mount portion 404 by connector 406. Additionally, outer mount portion 408 may be configured to rotate around inner mount portion 404 while inner mount portion 404 is in the unlocked state. Similarly, outer mount portion 408 may be secured in a rotational position while inner mount portion 404 is in the locked state.

In various embodiments, frame base 442 of outer mount portion 408 may be configured to receive inner mount portion 404 within internal socket 444. In particular, internal socket 444 may be configured to have an internal radius R2 greater than external radius R1 of perimeter structure 424. It should be noted that an internal surface of internal socket 444 may comprise one or more protrusions, extensions, teeth, and/or other raised portions configured to interface with one or more position locks disposed on the external surface of perimeter structure 424. While the internal surface has the internal radius R2, the one or more protrusions, extensions, teeth, and/or other raised portions may extend inward from the internal surface to a raised portion inner radius less than the internal radius R2. Similarly, the external surface may be associated with the external radius R1 and the one or more position locks may extend from the external surface of perimeter structure 424 to a position lock radius greater than external radius R1. A position lock height may be equal to the difference between external radius R1 and the position lock radius. Similarly, a raised portion height may be equal to the difference between internal radius R2 and the raised portion inner radius. It should be noted that external radius R1 may be less than the raised portion inner radius and internal radius R2 may be greater than the position lock radius.

In various embodiments, inner mount portion 404 may be installed within outer mount portion 408 to enable outer mount portion 408 to rotate around inner mount portion 404. In particular, connector hull 432 may be installed within central channel 430 opposite outer mount portion 408. Additionally, second ridge 436 may be associated with inner mount portion 404 opposite connector hull 432. It should be noted that connector hull 432 and second ridge 436 may be disposed coaxially with a central axis of inner mount portion 404. Inner mount portion 404 may be inserted within internal socket 444 such that connector hull 432 is disposed opposite outer mount portion 408 and second ridge 436 is disposed between inner mount portion 404 and connector interface 448. Second ridge 436 may be received at least partially by connector seat 452. Further, access plate 438 may be installed within an access socket 450 opposite connector seat 452. Accordingly, installation of fastener 440 may secure inner mount portion 404 and outer mount portion while enabling rotation of outer mount portion 408 around inner mount portion 404.

In various embodiments, fastener 440 may secure inner mount portion 404 and outer mount portion 408 via connector 406. In particular, connector hull 432 may secure a first side of inner mount portion 404, the first side proximate to mount interface 402. Additionally, second ridge 436 may secure a second side of inner mount portion 404 and a third side of outer mount portion 408, the second side opposite the first side and the third side proximate to the second side. Further, access plate 438 may secure a fourth side of outer mount portion 408, the fourth side opposite the third side. Installation of fastener 440 within connector hull 432 may apply a securing force to connector hull 432 that applies compressive force to inner mount portion 404 that presses inner mount portion into internal socket 444. Installation of fastener 440 within connector hull 432 may apply compressive force to outer mount portion 408 (e.g., via access plate 438) that presses outer mount portion 408 onto perimeter structure 424 such that internal socket 444 is radially outward of perimeter structure 424.

In various embodiments, mount arm 410 may be installed proximate to socket frame 446. In particular, socket frame 446 may comprise a first frame portion and a second frame portion that extend from frame base 442. For example, first frame portion may extend from a first side of frame base 442 and second frame portion may extend from a second side of frame base 442, the second side opposite the first side. Alternatively, or in addition, first frame portion may extend from frame base 442 in a first direction along the third axis A3 and second frame portion may extend from frame base 442 in a second direction along the third axis A3 opposite the first direction. Mount arm 410 may extend in the first direction and the second direction proximate to first frame portion and/or second frame portion. For example, mount arm 410 may be disposed between first frame portion and second frame portion.

In various embodiments, socket frame 446 and mount arm 410 may extend in a first direction along the first axis A1, a second direction along the first axis, and/or a third direction along the second axis A2 to define an accessory socket. In particular, socket frame 446 and mount arm 410 may comprise one or more angled, curved, and/or otherwise bent portion to at least partially enclose the accessory socket. Mount arm 410 may transition between an open state and a closed state in response to an applied force along the second axis A2, the applied force permitting an accessory to be receive within the accessory socket and removal of the applied force permitting mount arm 410 to secure the accessory in association with the accessory socket.

In various embodiments, mount arm 410 may comprise a fastener socket 454. Fastener socket may be disposed at a central axis of mount arm 410. Installation of mount arm 410 may align fastener socket 454 with central channel 430 of connector 406. Accordingly, installation of fastener 440 within connector hull 432 may secure mount arm 410 in association with frame base 442.

In various embodiments, a central axis may extend through the mount and define a point of rotation for the accessory associated with the mount. In particular, the central axis may extend through inner mount portion 404, connector 406, outer mount portion 408, and mount arm 410. Fastener 440 may be configured to extend through each component of the mount (e.g., inner mount portion 404, connector 406, outer mount portion 408, mount arm 410, etc.). Fastener 440 may be configured to secure each component of the mount together when the mount is assembled. Additionally, connector 406 may be configured such that outer mount portion 408 rotates around inner mount portion 404 when secured together by fastener 440. Further, second ridge 436 may be formed to permit rotation of outer mount portion 408 and minimize friction points to avoid seizing of outer mount portion 408 relative to inner mount portion 404.

In various embodiments, inner mount portion 404 may be at least partially formed to repeatedly experience elastic deformation. In particular, perimeter structure 424 may be configured to repeated transition between a locked state and an unlocked state to permit rotation of outer mount portion 408. As a result, perimeter structure 424 may be formed from a metallic, elastomeric, polymeric, and/or other material selected to repeatedly transition between the locked state and the unlocked state. Further, the material selected to form perimeter structure 424 may be selected for toughness to avoid degradation of the one or more position locks and/or the perimeter structure 424 (e.g., position locks will repeated engage and disengage with one or more raised portions of outer mount portion 408). Similarly, mount arm 410 may be formed from a material selected to repeatedly transition from the open state to the closed state to receive and second the accessory at the accessory socket. Additionally, other portions of the mount (e.g., mount interface 402, inner mount portion 404, connector 406, outer mount portion 408, etc.) may be formed from a suitable metallic, organic, polymeric, elastomeric, ceramic, and/or other material for supporting the accessory and securing the accessory to the mounting surface.

In various embodiments, a mount base may comprise a mount interface, an inner portion, and an outer portion. The mount interface may releasably couple the mount base to a mounting surface. Additionally, the inner portion may be secured to the mount base and coupled to the outer portion. The outer portion may be configured to rotate around the inner portion. The mount base may further comprise an accessory socket, the accessory socket comprising a socket frame and a socket arm. The socket arm may be configured to releasably secure an accessory in association with the accessory socket. Further, the inner portion may comprise one or more position locks and one or more contact ridges, wherein the inner portion switches from a locked state to an unlocked state based at least on an applied force satisfying a force threshold. The outer portion may comprise one or more raised portions, wherein the one or more position locks couple with a first set of the one or more raised portions in response to the inner portion being associated with the locked state and a second set of the one or more raised portions translate along at least the one or more contact ridges in response to the inner portion being associated with the unlocked state.

The mount interface may be configured to couple with a mounting surface interface associated with the mounting surface. Similarly, the mounting surface may be a user of the accessory and the mount interface may secure the mount base to the user. The accessory socket may be defined by at least the socket frame to receive the accessory and associate the accessory with the mounting surface.

In various embodiments, the socket frame may comprise a first frame portion and a second frame portion. The first frame portion may extend from a first side of the mount base. Similarly, the second frame portion may extend from a second side of the mount base, the second side opposite the first side. Additionally, the first frame and the second frame may define, at least in part, the accessory socket to receive the accessory. Further, the first frame portion may be mirrored by the second frame portion such that the accessory socket is symmetrical. Alternatively, or in addition, the first frame portion and the second frame portion may be distinct such that the accessory socket is asymmetrical. The socket arm may be disposed between the first frame portion and the second frame portion. The socket arm may be associated with an open state and a closed state, the open state associated with an opening force causing the socket arm to permit insertion of the accessory within the accessory socket and the closed state associated with at least the accessory being secured within the accessory socket.

In various embodiments, the inner portion may further comprise a deformation volume that enables transition of the inner portion from the locked state to the unlocked state. In particular, the deformation volume may enable a perimeter portion of the inner portion to translate towards a central axis by a clearance distance associated with the one or more position locks. Additionally, the deformation volume may enable the perimeter portion to disengage the one or more position locks from the outer portion to modify and permits the outer portion to rotate around the inner portion.

In various embodiments, the inner portion may transition from the locked state to the unlocked state based at least in part on an applied force satisfying a force threshold associated with the inner portion. Additionally, the applied force may be applied to the outer portion and be transferred to the inner portion via one or more position locks, one or more raised portions, and/or other structures of the inner portion. Further, the outer portion may apply the applied force to the inner portion via one or more raised portions, teeth, knobs, extension, protrusions, and/or other structures of the outer portion that interface with the inner portion. The applied force may cause translation of the one or more position locks perpendicular to a rotational direction (e.g., cause perimeter portion 312 to translate towards axis point 308). As a result, the applied force may cause a perimeter portion of the inner portion to translate the one or more position locks a clearance distance (e.g., a distance greater than a height of the one or more position locks from the outer surface of the inner portion) that disengages the one or more perimeter locks from the outer portion.

In various embodiments, the outer portion may be configured to translate between a plurality of rotational positions. For example, the outer portion may translate from a first rotational position of the plurality of rotational positions to a second rotational position based at least on the outer portion receiving an applied force greater than a force threshold. It should be noted that the outer portion may repeatedly translate between individual rotational positions from the plurality of rotational positions.

In various embodiments, a mount may comprise a first frame portion, a second frame portion, a mount arm, and a mount base. In particular, a first frame portion may define at least a first portion of an accessory socket. Similarly, the second portion may define at least a second portion of the accessory socket. Additionally, a mount arm may be configured to releasably couple with an accessory associated with the accessory socket. The mount arm may be disposed between the first frame portion and the second frame portion. Further, the mount base may be configured to rotate the accessory socket around a central axis. The mount base may comprise an outer portion that is associated with a plurality of rotational positions. The outer portion may be coupled to the first frame portion, the second frame portion, and/or the mount arm. The mount base may further comprise an inner portion associated with a locked state and an unlocked state. The locked state may secure the outer portion in a first rotational position and the unlocked state may enable rotation of the outer portion from the first rotational position to the second rotational position.

In various embodiments, the first frame portion may extend from a first side of the outer portion and the second frame portion may extend from a second side, the second side opposite the first side. The first frame portion may extend from the first side of the outer portion and angle away from the mount base. The second frame portion may extend from the second side of the outer portion and angle away from the mount base. Additionally, the first frame portion and the second frame portion may at least partially enclose the accessory socket. The mount may further comprise a frame base that couples the first frame portion and the second frame portion to the outer portion. The central axis may be configured as a fastener that couples the mount arm, the frame base, and the outer portion to the inner portion of the mount base, the fastener enabling the mount arm, the frame base, and the outer portion to rotate around the inner portion. It should be noted that the fastener may be configured to couple with at least the inner portion while securing the mount arm, the frame base, and the outer portion. Securing the mount arm, the frame base, and the outer portion may permit rotation relative to the inner portion while preventing sliding movement along the inner portion and/or removal of outer portion from inner portion.

In various embodiments an inner portion of the mount may comprise one or more first couplings. Similarly, an outer portion may comprise one or more second couplings. The one or more first couplings and the one or more second couplings, in the locked state of the inner portion, may secure the outer portion in the first rotational position. Additionally, the one or more first couplings and the one or more second couplings, in the unlocked state of the inner portion, permit the outer portion to rotate around the inner portion. The locked state of the inner portion may secure the accessory socket in the first rotational position. Transitioning from the locked state to the unlocked state may be caused by an applied force satisfying a force threshold. The unlocked state of the inner portion may permit the outer portion and the accessory socket to translate from the first rotational position through a subset of the plurality of rotational positions to the second rotational position. The unlocked state may transition to the locked state based at least on an applied force satisfying an additional force threshold. The additional force threshold may be less than the force threshold. Alternatively, or in addition, satisfying the additional force threshold may be associated with the applied force no longer satisfying the force threshold.

In various embodiments, a mount base may comprise an outer portion and an inner portion. The outer portion may be associated with a plurality of rotational positions. Additionally, the outer portion may comprise a frame base and one or more raised portions disposed on a radially inward surface of the outer portion. The inner portion may be disposed radially within the outer portion and associated with a locked state and an unlocked state. The locked state may comprise one or more position locks that secure the outer portion in a rotational position of the plurality of rotational positions. The one or more position locks may couple with one or more raised portions of the outer portion, the one or more position locks disposed radially outward of a central axis. The unlocked state may comprise the one or more position locks releasing the one or more raised portions of the outer portion and permitting the outer portion to rotate around the inner portion. The inner portion may be coupled to a mount interface that attaches to a mounting surface.

In various embodiments, a mount base may be associated with an outer portion that comprises an internal socket configure to receive an inner portion. Additionally, an internal radius of the internal socket may be greater than an external radius of the inner portion such that the inner portion is received by the internal socket. One or more raised portions may extend from an internal surface of the internal socket of the outer portion. Additionally, one or more position locks may extend from an external surface of the inner portion. Further, the inner portion may be received by the internal socket such that the one or more position locks interface with the one or more raised portions in the locked state. The outer portion may further comprise an access plate removably coupled to the frame base within an access socket. The inner portion may further comprise one or more mount points enabling the mount base to be coupled to a mounting surface, the one or more mount points accessed via the access socket.

Benefits, other advantages, and solutions to problems have been described herein with regard to specific embodiments. Furthermore, the connecting lines shown in the various figures contained herein are intended to represent exemplary functional relationships and/or physical couplings between the various elements. It should be noted that many alternative or additional functional relationships or physical connections may be present in a practical system. However, the benefits, advantages, solutions to problems, and any elements that may cause any benefit, advantage, or solution to occur or become more pronounced are not to be construed as critical, required, or essential features or elements of the disclosures. The scope of the disclosure is accordingly to be limited by nothing other than the appended claims and their legal equivalents, in which reference to an element in the singular is not intended to mean “one and only one” unless explicitly so stated, but rather “one or more.” Moreover, where a phrase similar to “at least one of A, B, or C” is used in the claims, it is intended that the phrase be interpreted to mean that A alone may be present in an embodiment, B alone may be present in an embodiment, C alone may be present in an embodiment, or that any combination of the elements A, B, and C may be present in a single embodiment; for example, A and B, A and C, B and C, or A and B and C.

Systems, methods, and apparatus are provided herein. In the detailed description herein, references to “various embodiments,” “some embodiments,” “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described. After reading the description, it will be apparent to one skilled in the relevant art(s) how to implement the disclosure in alternative embodiments. Furthermore, no element, component, or method step in the present disclosure is intended to be dedicated to the public regardless of whether the element, component, or method step is explicitly recited in the claims. No claim element is intended to invoke 35 U.S.C. 112 (f) unless the element is expressly recited using the phrase “means for.” As used herein, the terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus.

Examples of various exemplary embodiments embodying aspects of the invention are presented herein. It will be appreciated that all the examples contained in this disclosure are given by way of explanation, and not of limitation.

We claim:

1. A mount comprising:
a mount base comprising a mount interface, an inner portion, and an outer portion; and
an accessory socket comprising a socket frame and a socket arm, the socket arm configured to releasably secure an accessory in association with the accessory socket, wherein:
the mount interface releasably couples the mount base to a mounting surface;
the inner portion is secured to the mount base and coupled to the outer portion;
the outer portion is configured to rotate around the inner portion;
the inner portion comprises one or more position locks;
the inner portion switches from a locked state to an unlocked state based at least on an applied force satisfying a force threshold; and
the outer portion comprises one or more raised portions, wherein the one or more position locks couple with a first set of the one or more raised portions in response to the inner portion being associated with the locked state and a second set of the one or more raised portions translate along at least the inner portion in response to the inner portion being associated with the unlocked state.

2. The mount of claim 1, wherein the mount interface is configured to couple with a mounting surface interface associated with the mounting surface.

3. The mount of claim 1, wherein:
the socket frame comprises a first frame portion and a second frame portion; and:
the first frame portion extends from a first side of the mount base;
the second frame portion extends from a second side of the mount base, the second side opposite the first side; and
the first frame portion and the second frame portion at least partially define the accessory socket to receive the accessory.

4. The mount of claim 3, wherein the socket arm is disposed between the first frame portion and the second frame portion.

5. The mount of claim 1, wherein the socket arm is associated with an open state and a closed state, the open state associated with an opening force causing the socket arm to permit insertion of the accessory within the accessory socket and the closed state associated with at least the accessory being secured within the accessory socket.

6. The mount of claim 1, wherein:
the inner portion comprises a deformation volume that enables transition of the inner portion from the locked state to the unlocked state; and
the deformation volume enables a perimeter portion of the inner portion to translate towards a central axis by a clearance distance associated with the one or more position locks.

7. The mount of claim 1, wherein:
the applied force causes translation of the one or more position locks perpendicular to a rotational direction; and
the applied force causes a perimeter portion of the inner portion to translate the one or more position locks a clearance distance to disengage the one or more position locks from the outer portion.

8. The mount of claim 1, the outer portion configured to translate between a plurality of rotational positions, wherein the outer portion translates from a first rotational position of the plurality of rotational positions to a second rotational position based at least on the outer portion receiving the applied force.

9. The mount of claim 1, the inner portion further comprising one or more contact ridges, wherein the second set of the one or more raised portions translate along the one or more contact ridges of the inner portion.

10. The mount of claim 9, wherein the one or more contact ridges transition the inner portion from the unlocked state to the locked state based at least on the applied force satisfying an additional force threshold.

11. A mount comprising:
a first frame portion defining at least a first portion of an accessory socket;
a second frame portion defining at least a second portion of the accessory socket;
a mount arm configured to releasably couple with an accessory associated with the accessory socket, the mount arm disposed between the first frame portion and the second frame portion; and
a mount base configured to rotate the accessory socket around a central axis, the mount base comprising:
an outer portion associated with a plurality of rotational positions and coupled to the first frame portion, the second frame portion, and the mount arm; and
an inner portion associated with a locked state and an unlocked state, the locked state securing the outer portion in a first rotational position and the unlocked state enabling rotation of the outer portion from the first rotational position to a second rotational position.

12. The mount of claim 11, wherein the first frame portion extends from a first side of the outer portion and the second frame portion extends from a second side, the second side opposite the first side.

13. The mount of claim 12, wherein:
the first frame portion extends from the first side of the outer portion;
the second frame portion extends from the second side of the outer portion; and
the first frame portion and the second frame portion at least partially enclose the accessory socket.

14. The mount of claim 11, wherein the central axis is a fastener that couples the mount arm, a frame base that couples the first frame portion and the second frame portion to the outer portion, and the outer portion to the inner portion of the mount base, the fastener enabling the mount arm, the frame base, and the outer portion to rotate around the inner portion.

15. The mount of claim 11, wherein:
the inner portion comprises one or more first couplings;
the outer portion comprises one or more second couplings;
the one or more first couplings and the one or more second couplings, in the locked state of the inner portion, secure the outer portion in the first rotational position in the locked state; and
the one or more second couplings and the one or more second couplings, in the unlocked state of the inner portion, permit the outer portion to rotate around the inner portion.

16. The mount of claim 15, the locked state of the inner portion securing the accessory socket in the first rotational position and transitioning to the unlocked state based at least on an applied force satisfying a force threshold.

17. The mount of claim 15, the unlocked state of the inner portion permitting the outer portion and the accessory socket to translate from the first rotational position through a subset of the plurality of rotational positions to the second rotational position.

18. A mount base comprising:
an outer portion associated with a plurality of rotational positions and comprises a frame base and one or more raised portions disposed on a radially inward surface of the outer portion; and
an inner portion disposed radially within the outer portion and associated with a locked state and an unlocked state, wherein:
the locked state comprises one or more position locks that secure the outer portion in a rotational position of the plurality of rotational positions and couple with one or more raised portions of the outer portion, the one or more position locks disposed radially outward of a central axis; and
the unlocked state comprises the one or more position locks releasing the one or more raised portions of the outer portion and permitting the outer portion to rotate around the inner portion.

19. The mount base of claim 18, wherein the outer portion comprises an internal socket configured to receive the inner portion.

20. The mount base of claim 19, wherein:
the one or more raised portions extend from an internal surface of the internal socket of the outer portion;
the one or more position locks extend from an external surface of the inner portion; and
the inner portion is received by the internal socket such that the one or more position locks interface with the one or more raised portions in the locked state.
